(19) United States
(12) Patent Application Publication
(10) Pub. No.: US 2017/0039190 A1
(43) Pub. Date: Feb. 9, 2017

(54) Two Way (+) Language Translation Communication Technology

(71) Applicant: Joseph Ricardo, Orlando, FL (US)

(72) Inventor: Joseph Ricardo, Orlando, FL (US)

(21) Appl. No.: 15/229,132

(22) Filed: Aug. 5, 2016

(51) Int. Cl. G06F 17/28; G10L 13/08; G10L 15/26

(52) U.S. Cl. CPC G06F 17/2836; G10L 15/26; G10L 13/08; G06F 17/289

(57) ABSTRACT

The two way plus verbal communication technology will allow for two or more people to communicate with one another in real time by converting the spoken word from one communicator (sender) to the other communicator (receiver) by converting both of their primary or preferred languages between both parties in real time.

The Two way plus text translator will allow for two or more people to communicate with one another in real time through typed word by converting their texts into the preferred language of each receiving party.

The Two Way plus conference communication translator takes the text translator a step further allowing communication between numerous parties whom speak different languages. This technology will allow numerous people to communicate in real time between numerous devices via the internet.

Provisional Patent 62/282,560 Originally filed Aug. 5, 2015

Patent application Ser. No. 15/229,132 Originally filed Aug. 5, 2016

### BACKGROUND

The world we live in presents several barriers, the most limiting barrier being that of language communication barriers. Language barriers exist between the seven billion plus people on this planet in numerous forms. While there are companies that provide products and services that will help a person learn a second language, as well as products that will translate text into another language, a product does not exist that allows for two-way communication between two people of different languages in real time. The technology already exists in the form of speech to text technology, text translation technology, and text to speech technology. The integration of these three technologies into one uniform language translation software program will allow for any one person to communicate with virtually anyone else in the entire world.

A market exists for two-way translation communication devices throughout the world. The average person is not bilingual and those who are bilingual still face a communication barrier with people of numerous language backgrounds. Let us take for an example a person that has ability to speak the top five languages of the world those being Mandarin Chinese, Spanish, English, Hindi and Arabic. This person even with their extraordinary language skills would still be unable to communicate with people who spoke Portuguese, Bengali, Russian, Japanese and numerous other languages. The estimated number of languages spoken by the average person ranges from 1.58 to 1.69. So the average person speaks only one or two languages (and this average does not take into consideration polyglots or people who speak several languages) which if we take into consideration the top 20 languages in the world, there still exists an inability to directly communicate with 18 to 19 groups of people with a different native language than themselves. This does not take into consideration the fact that there are hundreds of languages on the planet.

The following is a list of prior art that presently appears to be relevant:

U.S. Patents

| Pat. No. | Kind Code | Issue Date | Patentee |
|---|---|---|---|
| 6,173,259 | B1 | 2001 Jan. 9 | Speech Machines PLC |
| 6,012,028 | A | 2000 Jan. 4 | Ricoh Company, Ltd. |
| 5,987,401 | A | 1999 Nov. 16 | Apple Computer, Inc. |
| 5,765,131 | A | 1998 Jun. 9 | British Tel. Public Lmtd. Co. |
| 5,966,685 | A | 1999 Oct. 12 | America Online, Inc. |
| 5,268,839 | A | 1993 Dec. 7 | Hitachi, Ltd. |

### SUMMARY

The New Millenia Company is petitioning for a patent of the three following independent claims:

1. Two-way plus verbal communication technology which allow for speech in one language to be sent and received by another party in their preferred language

2. Two-way plus language translation communication software programs ranging from instant messaging, texting, and email.

3. Two way plus conference communication where two to several people can have a conversation in real time, each person sending their communications in their preferred language while each receiving party receives the communication in their own preferred language. This technology will allow for people to communicate in different languages via chat room, forums, social media and other electronic forums on the internet.

These products will allow for people and businesses to communicate with people whose native languages are not of their own language. This would allow for someone whose native language is only English to communicate with people who for example speak Mandarin Chinese, Spanish, or Hindi. This would expand their potential customer base from approximately 300 million English speaking people to 1.9 billion Mandarin Chinese, 400 million Spanish and 260 million Hindi speakers; for a total of another 1.56 billion potential customers with who they otherwise would be unable to communicate as easily.

This technology and program will not only help people communicate with one another on a personal and social level but also allow for more communication in the business world. Imagine the potential for a business to expand their customer base if they were better able to communicate with people of several languages. Government agencies will have the ability to communicate diplomatically with other nations without the need of interpreters, government agencies at the Federal, State and local levels will have the ability to conduct their business and operations with any person in their preferred language.

### DRAWINGS & DETAILED DESCRIPTION

FIG. 1 Two-way voice communication translation technology

FIG. 1.A: Block Diagram showing translation methods from one language to another using voice

001 The application works via a computer, cellular phone, tablet or other electronic devices able to store electronic information and send and receive messages.

002 The communication is spoken into the cellular device or spoken into a microphone via the computer, tablet or any devices able to store electronic information and send and receive messages.

003 A & B The speech is than converted into text via the application using speech to text technology

004 The text which has been converted from voice is then sent to a receiving party via the internet

005 A & B The text from the sending party is then converted into the text of the receiving party's preferred language. This is done via translation technology from the text in one language into the text of another language. This will be accomplished either through the software installed on the receiving parties' device or through the internet if that device does not have the capability to store the software required.

006 A & B The translated text is then converted into speech of the receiving parties preferred language. This is done using text to speech technology.

007 Finally the receiving party will hear the sending parties message in their preferred language

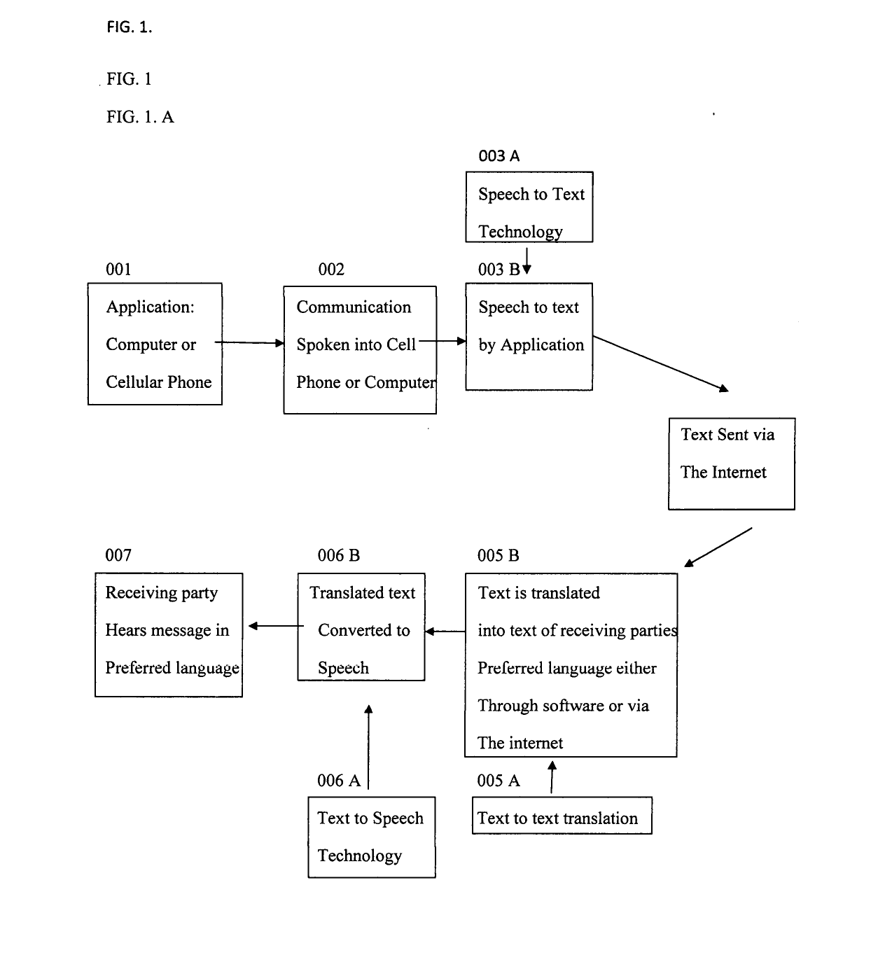

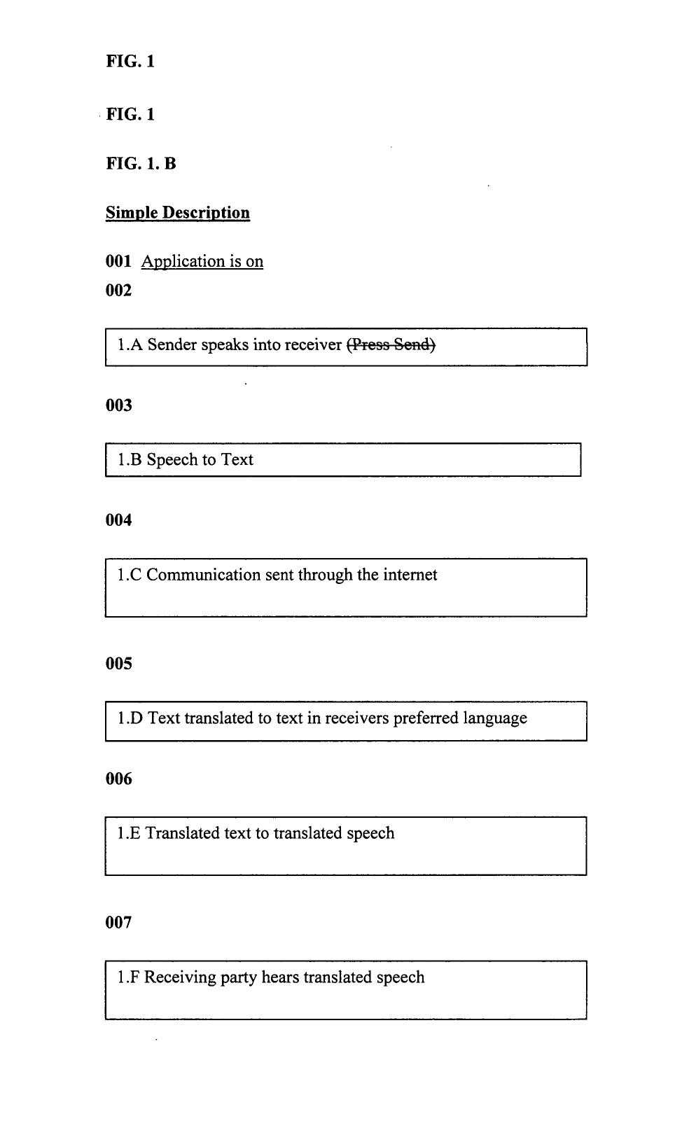

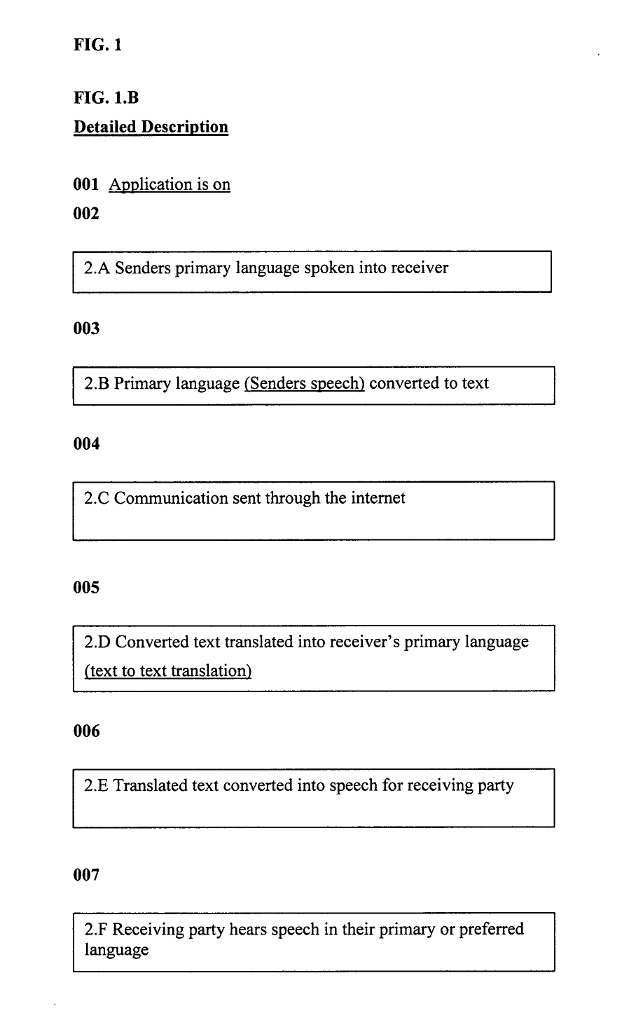

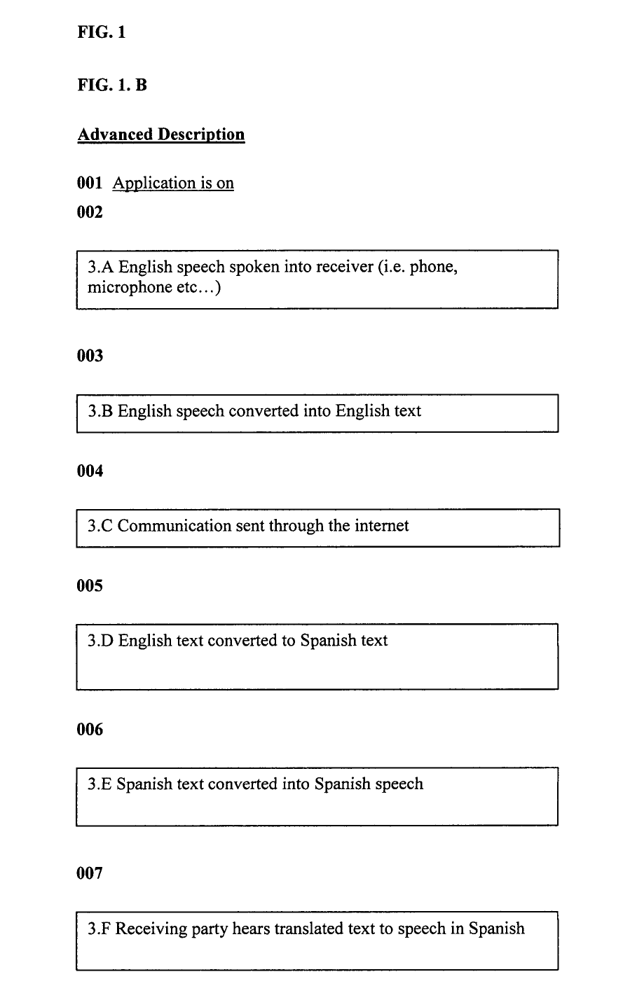

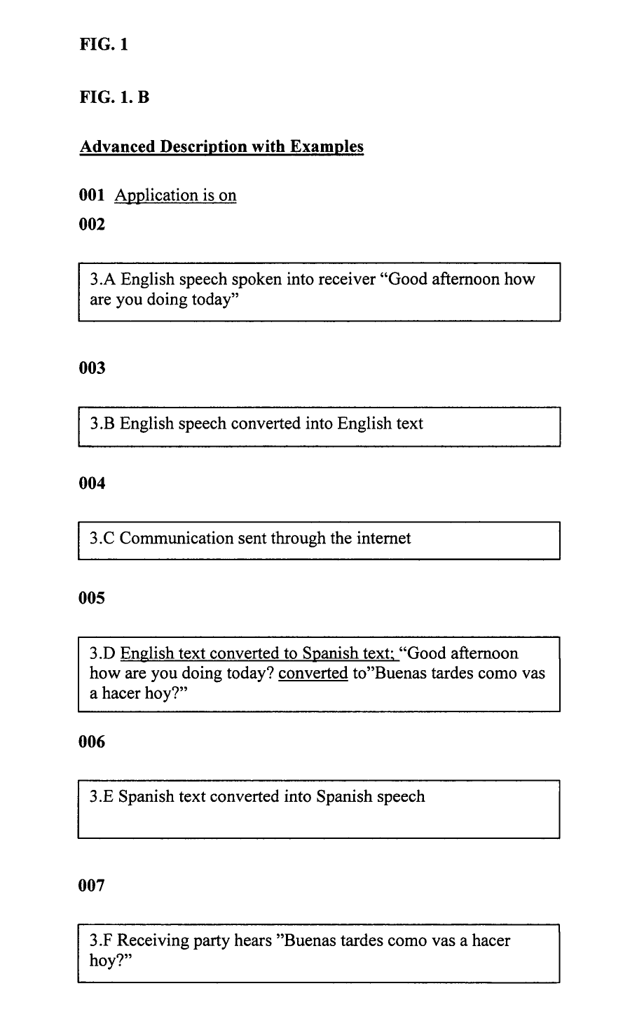

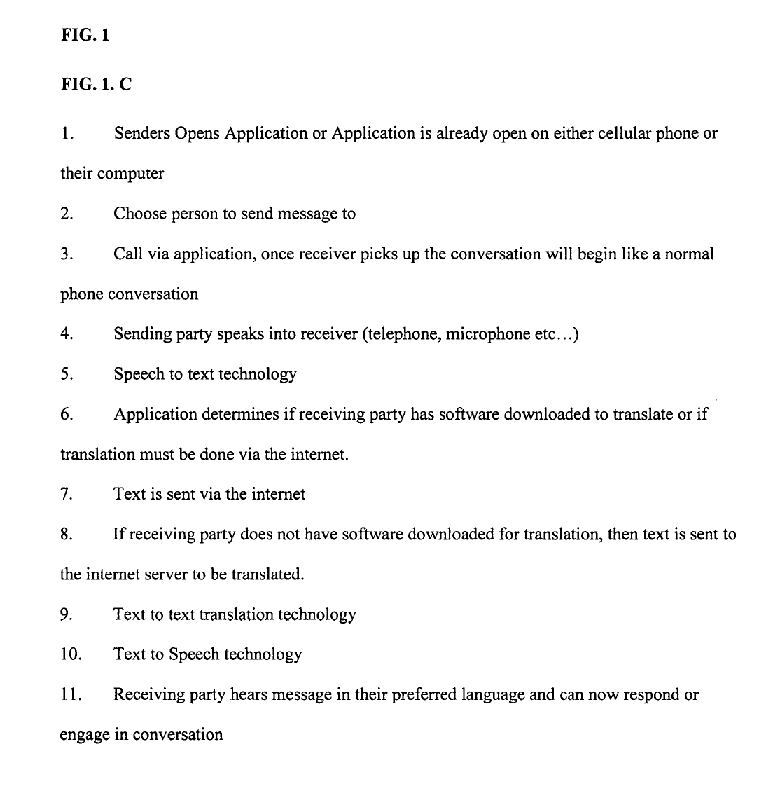

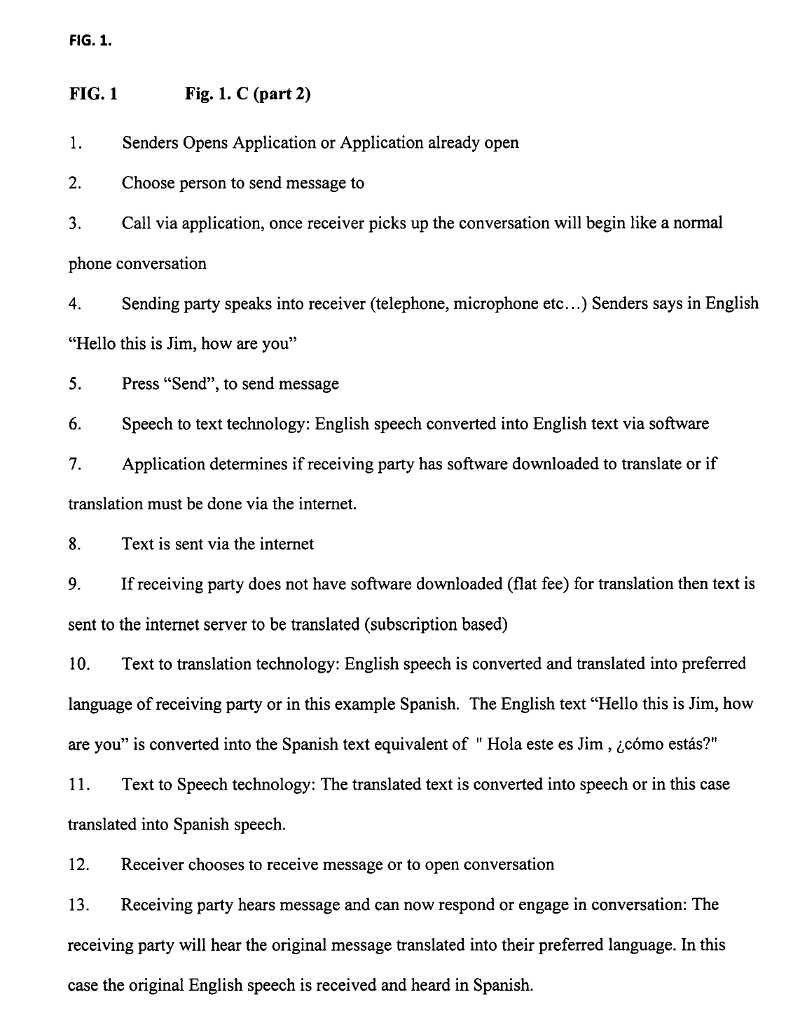

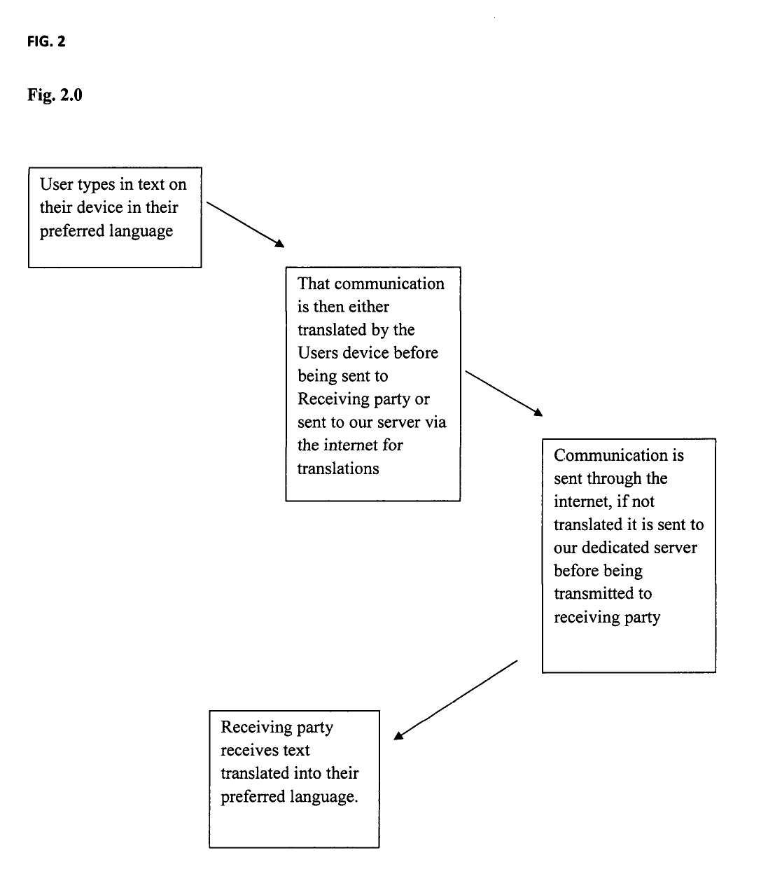

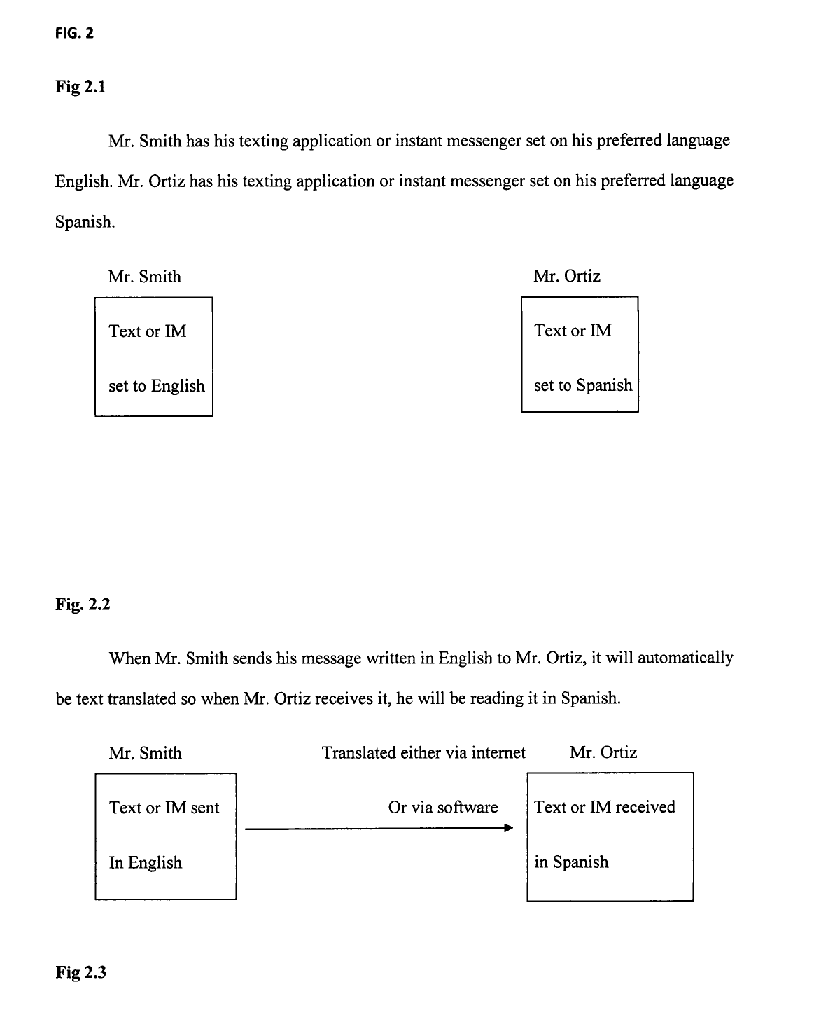

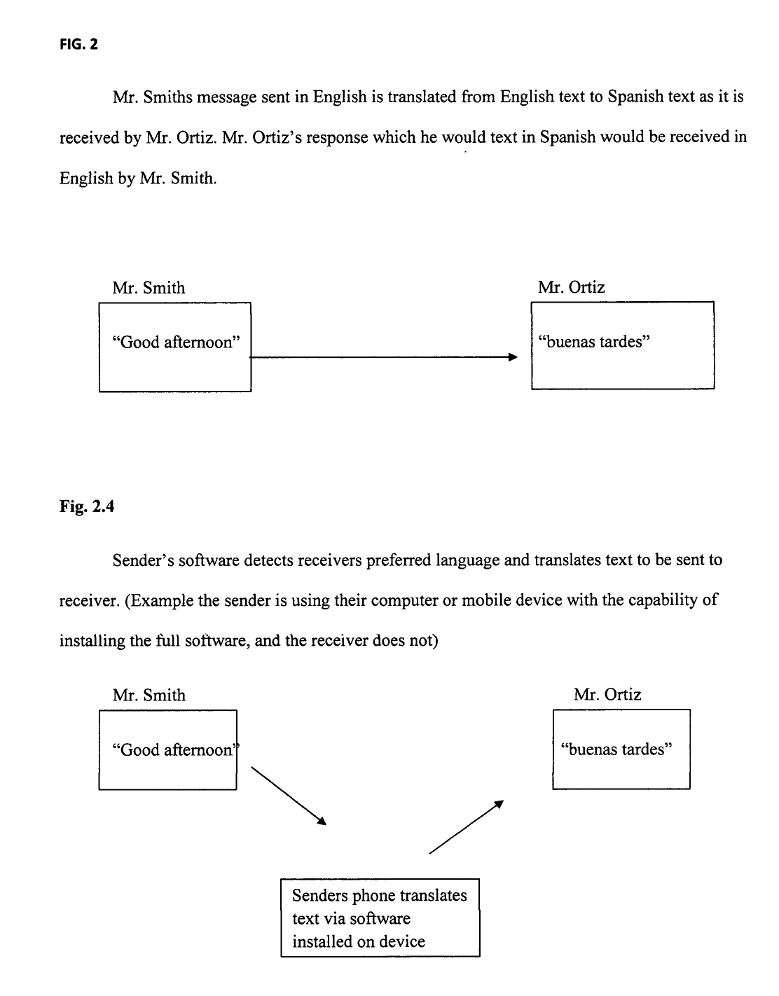

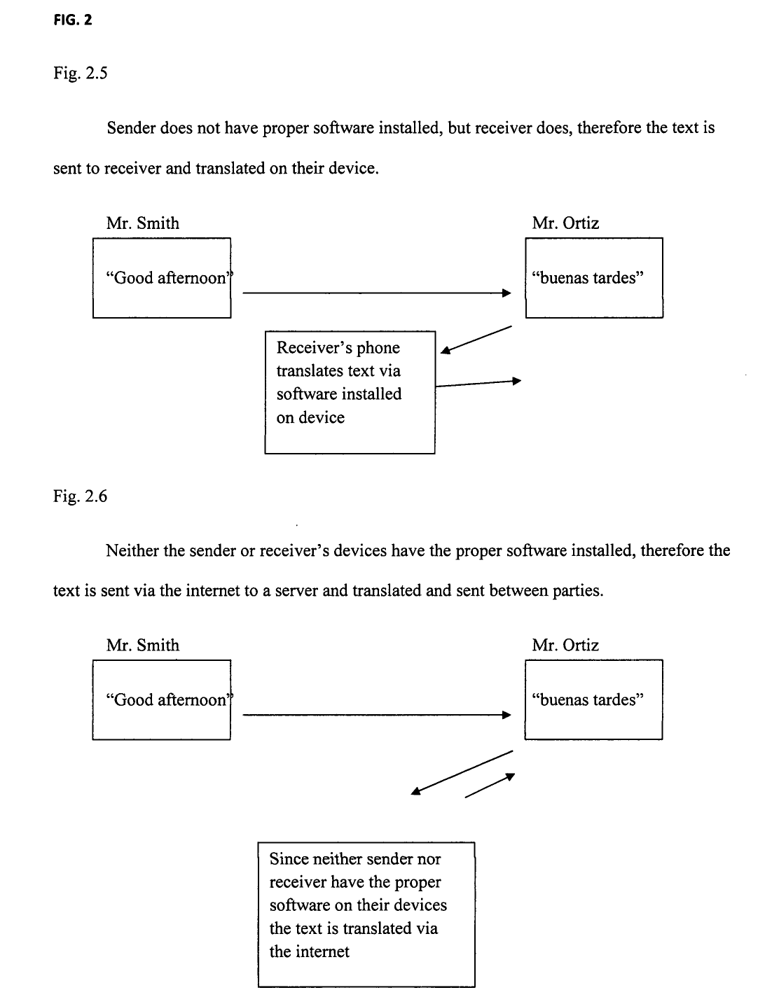

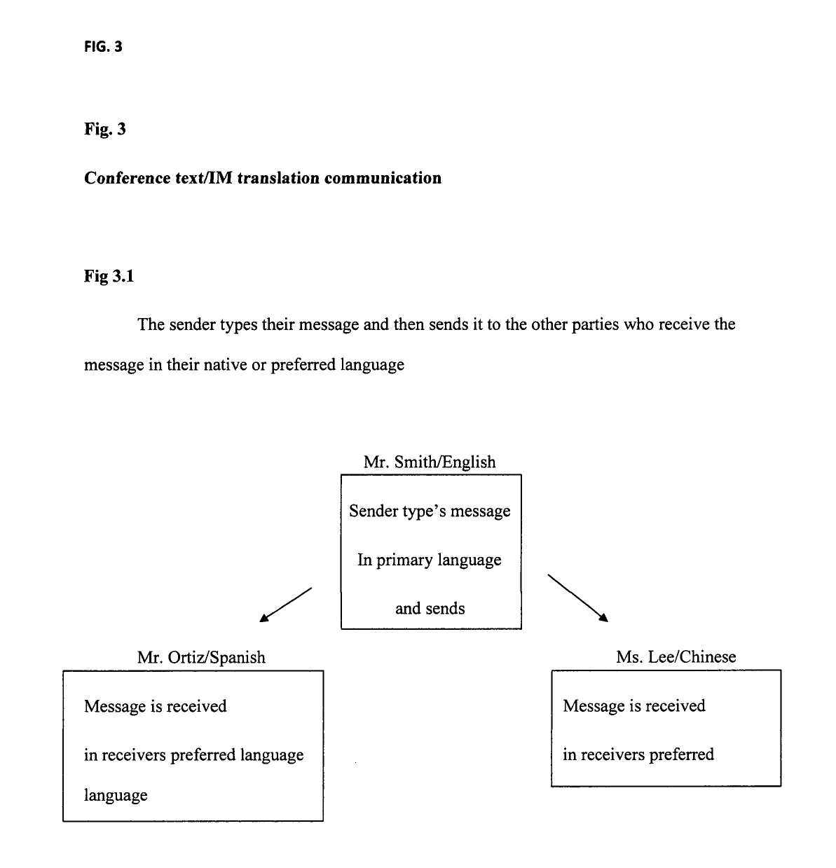

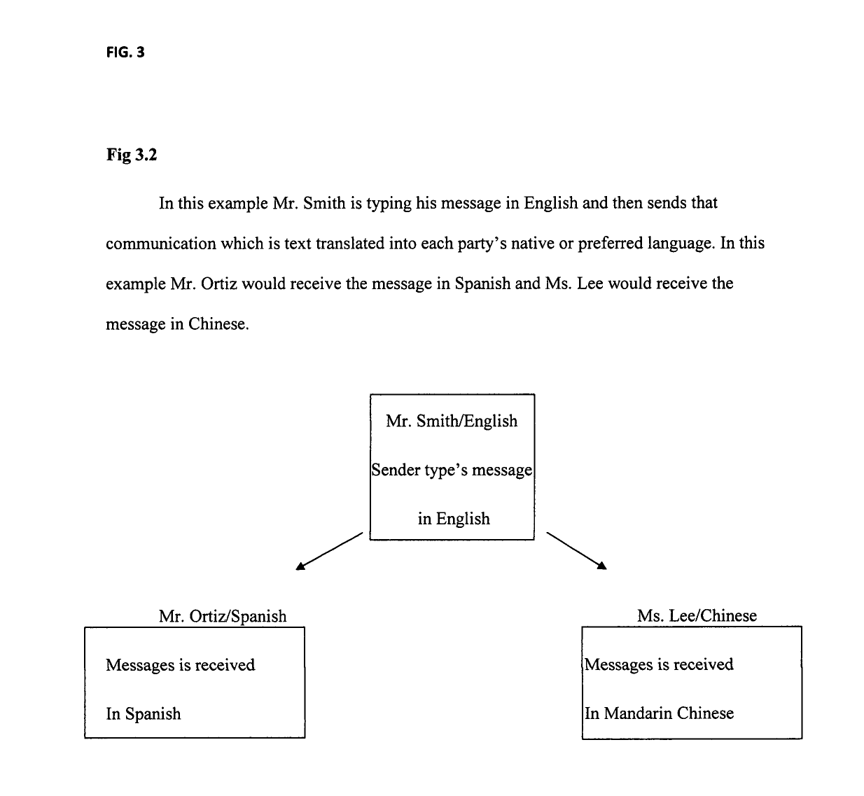

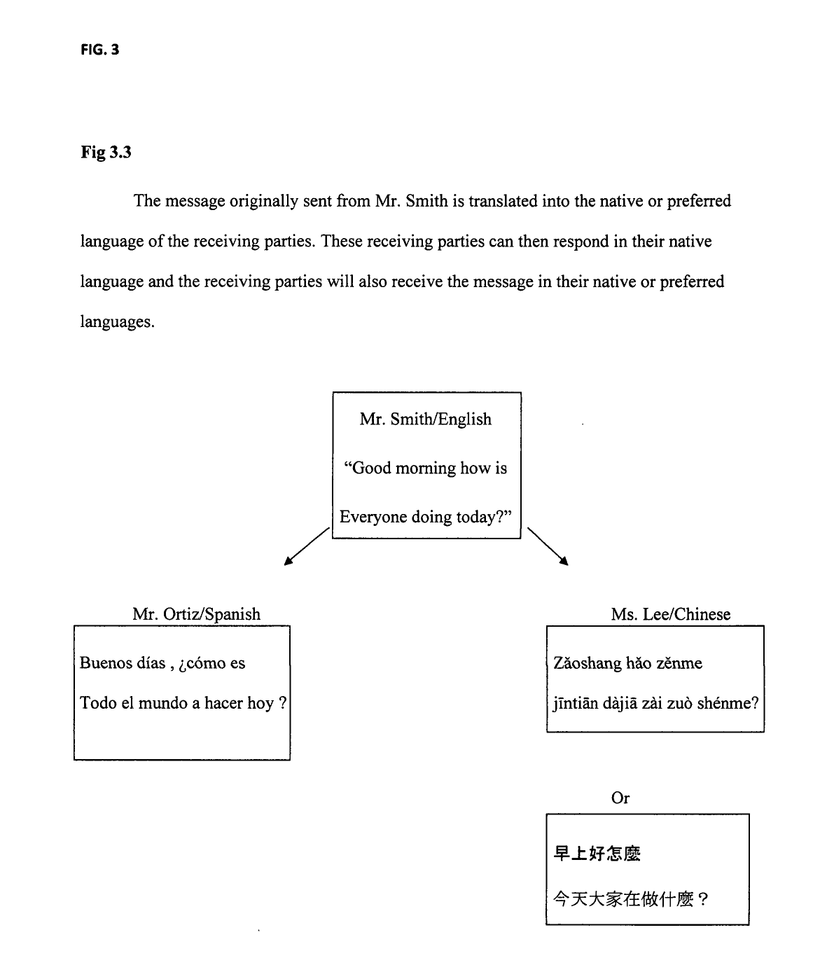

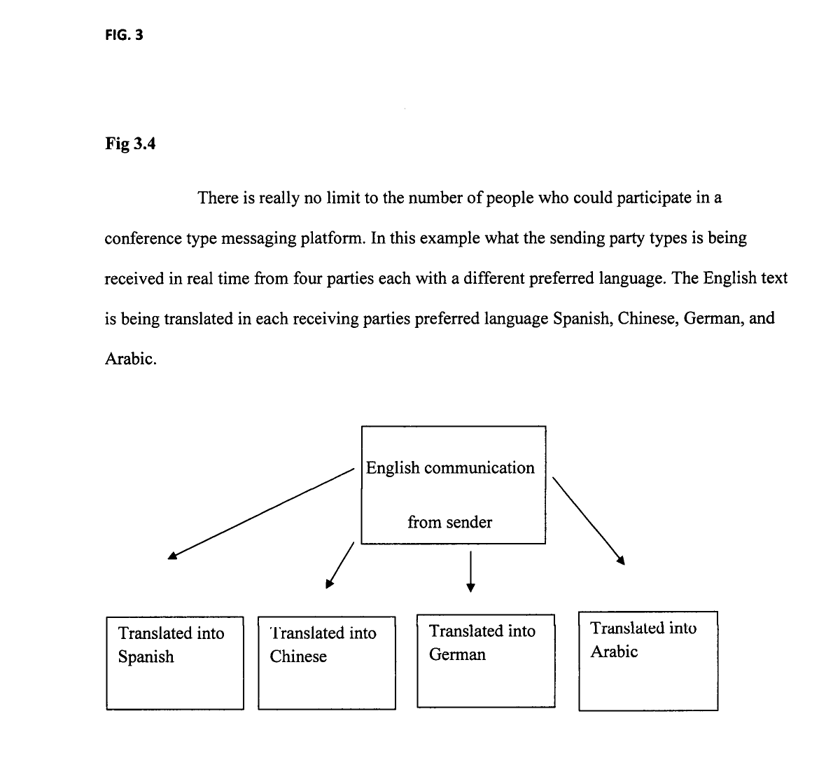

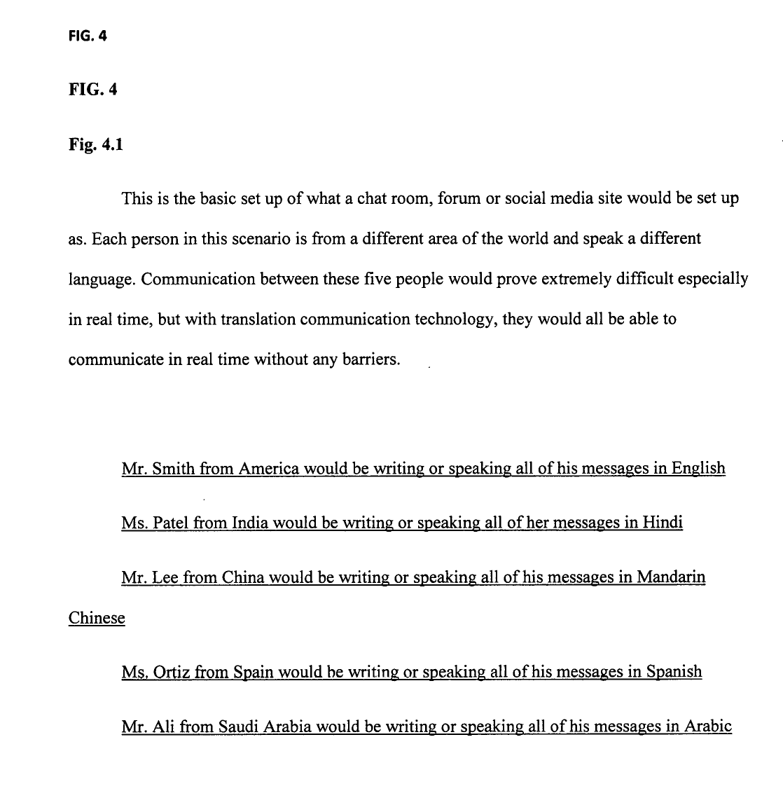

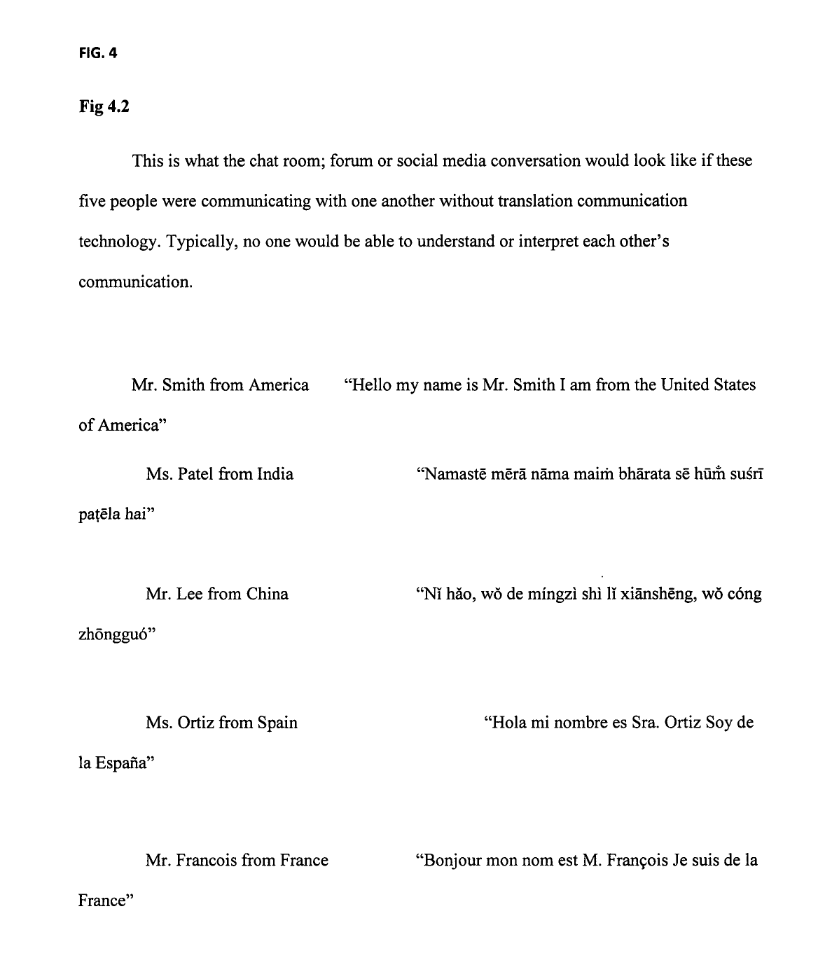

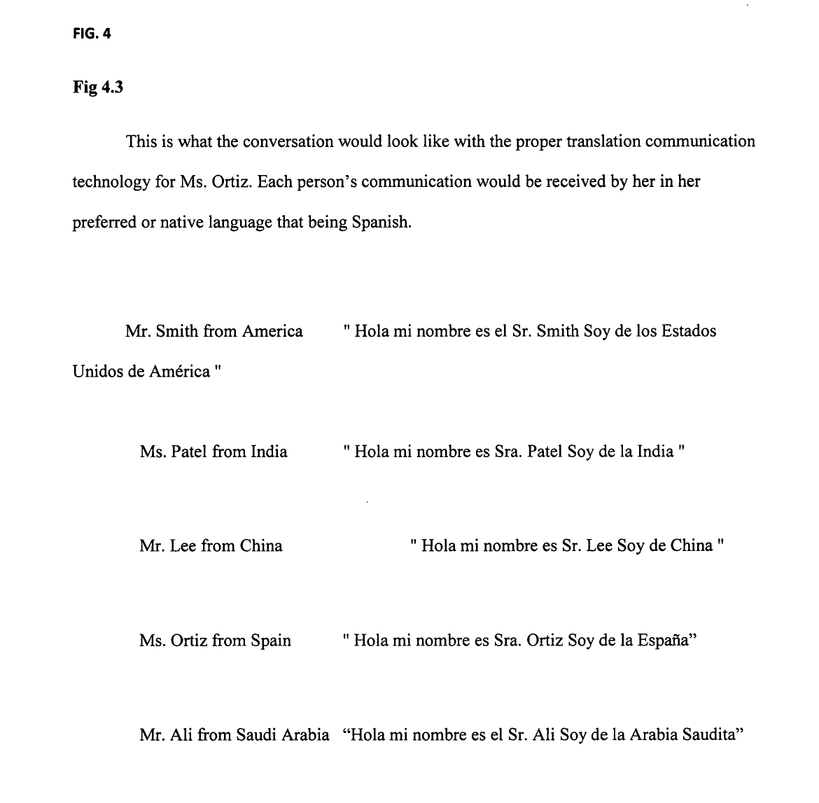

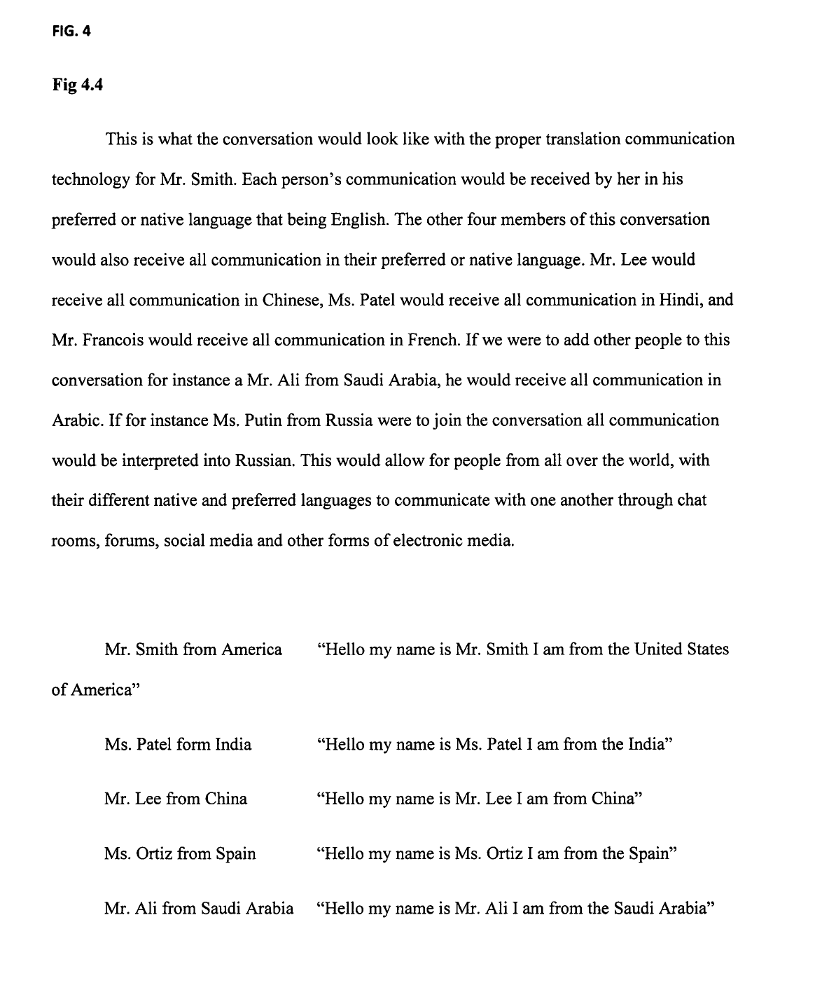

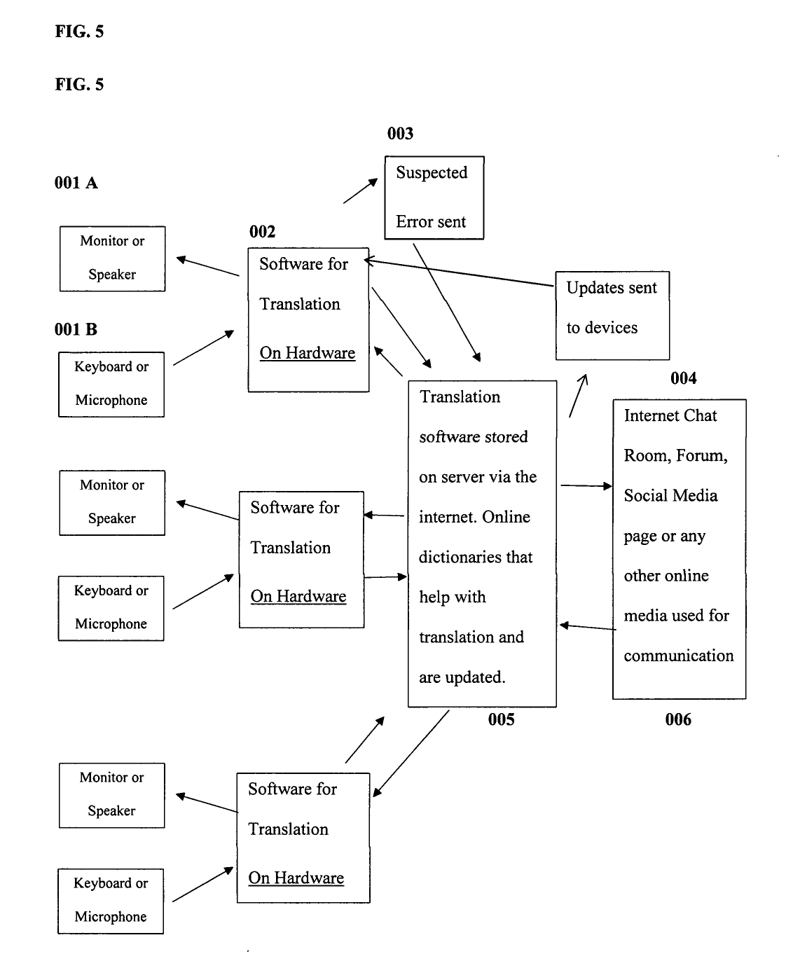

FIG. 1.B: Flow Chart showing operation performed by 1.A

This drawing shows the specific details of the operations of the Voice Communication Translation method

The first column represented by the letters 1.A through 1.F show a simple explanation of the process

The second column represented by the letter 2.A through 2.F shows a more detailed version of how the process works

The third column represented by the letter 3.A through 3.F shows an advanced detailed description of the method used in the translation software

The fourth column represented by the letter 4.A through 4.F shows and even more advanced description of the method used in the translation software giving an example of the method in translating English spoken language into Spanish

001 Represents the application being on

002 or row A, indicates the sender speaking into the receiver in their primary language which would be through a phone, microphone or other receiving device, the example in 3.A shows an example of the person speaking in their primary language

003 or row B, shows the method of speech to text technology which would translate the sender's primary language which was spoken into text of the senders spoken word, in 3.B the English spoken language is translated into English text

004 or row C, indicated the communication or text is then sent through the internet

005 or row D, shows text being translated into the text of the receivers preferred language. The text is converted from the sender's primary language into the receiver's primary language through text to text translation. In the example of 3.D and 4.D the English text is translated into Spanish text.

006 or row E, translated text is converted into translated speech of the receiving party. 3.E and 4.E show how the Spanish text is converted into Spanish speech.

007 or row F, shows that the receiving party hears the translated speech in their primary language or as described in 3.F and 4.F the receiving party hears the translated text to speech in Spanish

FIG. 1.C: Step by Step process as described in 1.A and 1.B as described in FIG. 1.B

This figure details what looks like an ordinary call done through an application but with the several translation processes in between such as speech to text, text to text translation and text to speech technologies.

FIG. 2 Two-way text translation technologies.

This figure details the simpler process of text to text automated translation between two parties using the texting application.

FIGS. 2.0-2.6: Block Diagrams showing schematics of the translation methods from one language to another using text

FIG. 2.0 Demonstrates how the software works by taking the text written by the user and either translating that text using the Sending parties' software or by sending it via the internet to our dedicated server for translation. Once that text has been translated via software it will be sent to the Receiving party in their preferred language.

FIG. 2.1 Demonstrates how the users on each end have already chosen their preferred language, so by default any messages sent to them will be translated into their chosen language.

FIG. 2.2 Demonstrates how the text would be translated either by the software on either user's device (if it has the capability) or would be translated via the internet on our dedicated server.

FIG. 2.3 demonstrates how the text would be sent and received from one language to another.

FIG. 2.4 provides an example of the text being translated from the users device as it is being sent.

FIG. 2.5 demonstrates how the program would detect if the other users device was capable to translation if the device had the ability to download the software required.

FIG. 2.6 demonstrates how if neither device is capable of storing the necessary software than the translation would be accomplished via the internet on our dedicated server.

FIG. 3 Two way plus Conference Communication via text or instant messenger.

FIGS. 3.1-3.4: Block Diagrams showing conference translation in text and instant messenger.

FIG. 3.1 Demonstrates how a communication in one language would be sent and translated into two different languages based on the other conference participants preferred language.

FIG. 3.2 Further demonstrates the text in English being translated into Spanish, and Chinese and being sent to the receiving parties.

FIG. 3.3 Shows an example of what the text would be input as, and how that text would be received as.

FIG. 3.4 Demonstrates the capability of sending a simple message between several people all of whom speak different languages and the ability to have a fluid conversation between all parties in real time.

FIG. 4 Two Way plus Conference Communication via Electronic media.

FIGS. 4.1-4.4: Flow Chart's showing translation methods in electronic media formats.

FIG. 4.1 Demonstrates how each individual person in a chat room conference, forum, or other media used to have conference call type conversations would be able to type their message in their native language and each user would receive the text of that conversation in their native language.

FIG. 4.2. Demonstrates how the conversation would appear if each person was typing their text in their native language without translation technology.

FIG. 4.3. Demonstrates how the conversation would look for a person whose preference is Spanish as everyone's text is converted and translated to Spanish.

FIG. 4.4. Demonstrates how the conversation would look for an English speaking person when everyone's text is converted into English using the language translation software.

FIG. 5 Two Way plus Conference Communication via Electronic media.

FIG. 5: Block Diagram showing translation methods in electronic media as explained in FIGS. 4.1-4.4

001.A. Is indicative of the monitor/screen and speaker that will relay the translated message to us.

001.B. Is indicative of the keyboard or microphone we would be using to speak, or type our communications

002. Is indicative of the software being used for translation via electronic storage device such as a computer, tablet, cellular phone or any other electronic device.

003. Indicates the part of our software that will detect errors or be used for the reporting of issues with the translation software.

004. Indicates the part of our software that will send updates to users devices as translations are updated and improved upon.

005. Is indicative of our dedicated servers used for translations that are sent between customers using our software.

006. Represents the chat rooms, forums, social media pages, and other online media using our translation software between customers.

### OPERATION

The operation of this product is useful in numerous personal, business and government functions. These products allow for two way communications between two people who speak separate languages. In real time these products will translate spoken or typed words between two or more people.

Government agencies at the Federal, State and local level could also use this technology to communicate with anyone in their own native language. Think of the advantages in immigration, criminal justice, education and healthcare this could provide. Any government agent would be able to communicate with any one person migrating to this country instead of needing to find a specific person with the capabilities to translate for a specific immigrant. Courts at various levels would not need the services of an interpreter to read a person their rights, conduct court or any other various situations that have the need for interpreters. Students at various levels could be serviced by anyone working for the school from admissions, financial aid, guidance counselors and so on. Online courses could easily use this technology to allow for students of various native languages to communicate via the online forum using the electronic media translation technology. A person seeking medical attention would not have their care delayed if for any reason no person was able to speak their native language. These are only a few examples of the numerous advantages this technology would provide.

Businesses would gain a huge advantage from this technology by expanding their direct customer base using this technology. The business would be able to hire people who speak any of the various languages and still be able to communicate with them in real time. Also let us imagine a sales team that could now communicate with anyone around the world in different languages instead of needing to hire bilingual people to communicate. For example, they previously would have to hire people who speak Spanish, Chinese etc. . . . to communicate with people from those markets. With this technology any one person whether their native language was English, Spanish etc. . . . will now have the capability to market, and sell the product to virtually anyone in the world.

1. A method for two-way translation via voice communication device that integrates (a.) Speech to text technology, (b.) Text to translation technology, and (c.) Translated text to speech technology.
a. The first step would be the speech to text technology, where a person would speak into the receiver and the words would be translated into text (for example English speech into English text)
b. The second step would be that the text would then be translated into the text of another language (the native or preferred language of the receiver). For example, the English text would be translated into the Spanish equivalent text as set by the receiving party.
c. The final step would be the translated text being translated from text to speech. For example, the text that was translated into Spanish would be converted Spanish text to Spanish speech to the receiving party.
d. The completed process would be as follows 1. English speech to English text, (Senders Primary language speech to Primary language text) 2. English text to translation into Spanish text, (Senders Primary language text is translated in receivers preferred language) and 3. Translated Spanish text to translated Spanish speech (receivers preferred language text translated into receivers preferred language speech).

2. Software that allows at a minimal capacity to display conversations conducted through the aforementioned methods in the users preferred language.

3. Extended software capability to allow for the translation to and from the user between themselves and others engaged in conversation.

4. A method for allowing either party to set their preferred language

5. A method for determining if either party has the software on their device to allow for translation via the software installed on their device. This would then allow for the translation between parties to occur through the software installed on their devices.

6. A method for determining that neither party has the software on their devices and sending voice or text to a server via the internet to be translated.

7. A method for the translation of text and instant messages between parties.
The sender types out their message and sends it to the receiving party. The text is translated either through software installed on sender or receiver's hardware device, or is translated via the internet.
The software on either parties' device will allow for the translation between both parties. If for any reason neither parties' device has the proper software installed on their device, then the communication will be translated via the internet between both parties, as explained in claims 2,3 and 4.

8. Group messaging technology that allows for the translation to the user's interface into their native or preferred language. This technology will work in a similar way as the text and instant messaging technology yet will allow for communication between numerous parties and through the various methods of communication through the internet and between devices. This could be in the form of chat rooms, forums and other group messaging software and technology.
